(19) United States
(12) Patent Application Publication
(10) Pub. No.: US 2009/0278290 A1
(43) Pub. Date: Nov. 12, 2009

(54) EASY-TO-INSTALL AIR SPRING

(75) Inventors: Mark Guy Trowbridge, Stow, OH (US); John S. Attinello, Uniontown, OH (US)

Correspondence Address: Alvin T. Rockhill, P. O. Box 1283, Bath, OH, 44210, US

(73) Assignee: VEYANCE TECHNOLOGIES, INC., Fairlawn, OH (US)

(21) Appl. No.: 12/117,344

(22) Filed: May 8, 2008

(51) Int. Cl. F16F 5/00

(52) U.S. Cl. 267/120

(57) ABSTRACT

An air spring generally comprises a first end closure, a flexible member coupled to the first end closure and defining a pressurizable chamber, and a first mounting member projecting from the first end closure in a first direction. The first mounting member has an outer surface with a plurality of barbs projecting outward from the outer surface. The barbs have a spaced arrangement along the first direction.

### TECHNICAL FIELD

This application generally relates to shock-absorbing components, and more specifically to air springs used in vehicles or machines.

### BACKGROUND

Pneumatic springs, commonly referred to as air springs, are used in motor vehicles to provide cushioning between movable parts. Air springs thus play an important role in the suspension systems of motor vehicles, especially tractor-trailer trucks. These air springs are designed to dampen vibrations and/or absorb shock loads impressed on the vehicle axles when the wheels of the vehicle strike an object in the road, such as a bump, depression, or other obstruction.

Conventional air springs typically include a flexible elastomeric sleeve or bag-like element that extends between a pair of end closures. At least one of the end closures is typically in the form of a rigid support plate or retainer. The sleeve is attached to the retainer in a seal-tight manner by clamping (e.g., with a clamp ring), swaging, or similar techniques. In rolling lobe air springs, the other end closure is in the form of a piston. The sleeve is also attached to the piston in a seal-tight manner, but forms a lobe configured to bear against the outer surface of the piston.

The end closures are mounted to spaced-apart components of the vehicle, and the sleeve forms a chamber between the end closures. Pressurized gas (e.g., air) within a chamber helps absorb the loads impressed on the spaced-apart components. For example, when the vehicle experiences a shock load that urges the components to move towards each other, most of the motion is absorbed by the pressurized chamber. In rolling lobe air springs, the lobe of the elastomeric sleeve rolls along the outer surface of the piston to absorb such loads.

One aspect of current air springs that can be improved is the mounting of the end closures to the vehicle components. Many air springs are bolted to the vehicle components. For example, one or both of the end closures may include a tapped hole configured to be aligned with a through hole in the vehicle component. A bolt is inserted through the vehicle component to engage the threads of the tapped hole, thereby securing the end closure to the vehicle component. Alternatively, one or both of the end closures may include a threaded projecting portion that serves as a bolt itself. The projecting portion is configured to extend through a hole in the vehicle component so that a nut may be secured onto the threads.

Using nuts and bolts to install an air spring to a vehicle requires the use of additional tools, such as a wrench. This can be cumbersome in areas of the vehicle where there is limited access to the intended location of the air spring. Furthermore, the difficulties associated with installing such air springs are also present when removing the air springs for repair or replacement. Although some attempts have been made to provide air springs having a snap-mounting feature, there remains room for improvement.

Therefore, an air spring with improved installation capabilities would be highly desirable.

### SUMMARY

An air spring generally comprises a first end closure, a flexible member coupled to the first end closure and defining a pressurizable chamber, and a first mounting member projecting from the first end closure in a first direction. The first mounting member has an outer surface with a plurality of barbs projecting radially outward from the outer surface. The barbs have a spaced arrangement along the first direction. When the member is inserted into a through-hole provided in a component to which the air spring is mounted, such as a suspension component of a vehicle, the barbs create a ratcheting-like effect to secure the air spring to the vehicle.

The plurality of barbs may comprise first and second sets of barbs located on diametrically opposite sides of the outer surface. For example, the first mounting member may be substantially cylindrical with first and second flat portions on opposite sides of the outer surface. The first set of barbs may be arranged along the first flat portion, while the second set of barbs may be arranged along the second flat portion.

In one aspect or embodiment, each barb has a triangular cross-section defined by the outer surface of the first mounting member, a leading surface extending outwardly from the outer surface and toward the first end closure at a first angle, and a trailing surface extending outwardly from the outer surface at a second angle. The leading and trailing surfaces converge at a corner or peripheral edge of the barb, and the first angle is less than the second angle. For example, the first angle may be approximately 30° and the second angle may be approximately 90°.

In another aspect or embodiment, the air spring further comprises a second end closure coupled to the flexible member opposite the first end closure. A second mounting member projects from the second end closure in a second direction and also includes a plurality of barbs. Either or both of the first and second mounting members may be integrally formed with the associated end closure. When the components are integrally molded, the first end closure may be molded from a first material and the first mounting member may be molded from a second material having a lower stiffness than the first material.

A method of forming an air spring is also provided. The method generally comprises constructing an end closure, constructing a mounting member having an outer surface with a plurality of barbs projecting radially outward, coupling the mounting member to the end closure so that the mounting member projects from the end closure in a first direction, and coupling the end closure to a flexible member. The plurality of barbs are arranged along the first direction, and the flexible member defines a pressurizable chamber.

In one embodiment of the method, the mounting member is integrally formed with the end closure. For example, constructing the end closure may comprise molding the end closure from a first material, constructing the mounting member may comprise molding the mounting member from a second material having a lower stiffness than the first material, and coupling the mounting member to the end closure may comprise integrally molding the mounting member with the end closure.

### BRIEF DESCRIPTION OF THE DRAWINGS

FIG. 1 is a perspective view showing an air spring according to one embodiment installed between two components of a vehicle.

FIG. 2 is a perspective view of a portion of the air spring shown in FIG. 1.

FIG. 3 is a front elevation view of the air spring portion shown in FIG. 2.

FIG. 3A is an enlarged view of the area circled in FIG. 3.

FIG. 4 is a top plan view of the air spring portion shown in FIG. 2.

FIG. 4A is an enlarged view of the area circled in the FIG. 4.

### DETAILED DESCRIPTION

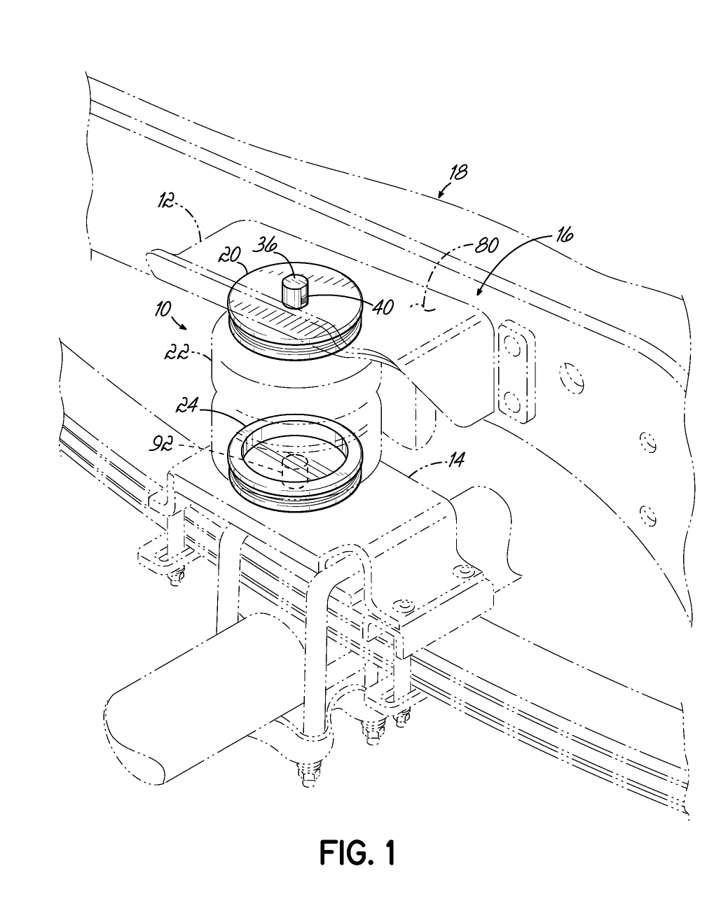

FIG. 1 shows one embodiment of an air spring 10 installed between a first component 12 and a second component 14 in the suspension system 16 of a vehicle 18. The air spring 10 generally comprises a first end closure 20 and a flexible member 22 coupled to the first end closure 20. The air spring 10 may also include a second end closure 24 coupled to the flexible member 22 opposite the first end closure 20. Because the flexible member 22 defines a pressurizable chamber between the first end closure 20 and the second end closure 24 in a manner similar to conventional air springs, the flexible member 22 is now shown in detail. Those skilled in the art will also appreciate that the first component 12 and second component 14 are also exemplary in nature, and thus do not need to be described or shown in detail as well. The description below instead focuses on features that allow the air spring 10 to be easily installed to the first component 1 2 and/or the second component 14.

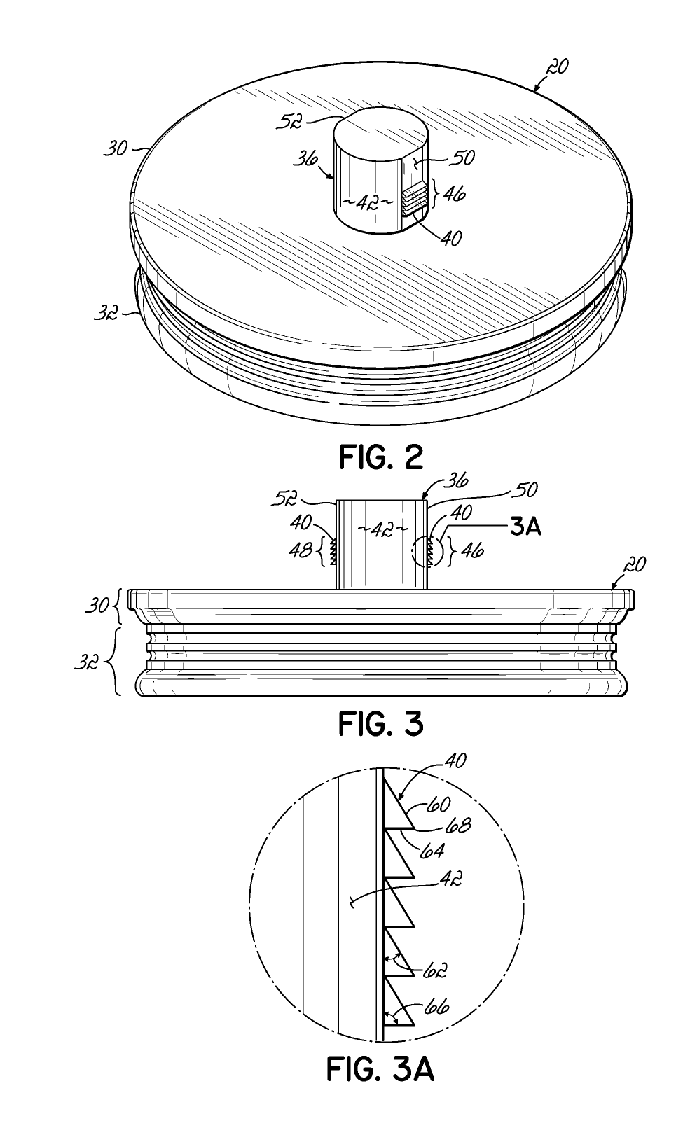

For example, FIGS. 2 and 3 illustrate the first end closure 20 in further detail. The first end closure 20 may include a generally cylindrical upper portion 30 configured to bear against the first component 1 2 and a lower portion 32 to which the flexible member 22 is coupled. The flexible member 22 may be coupled to the lower portion 32 in a variety of ways. For example, a clamp ring (not shown) may be used to secure the flexible member 22 to the lower portion 32. Alternatively or additionally, the lower portion 32 may be deformed or swaged to retain a portion of the flexible member 22. Still further, the flexible member 22 may be integrally formed with the first end closure 20. The shape and configuration of the lower portion 32 will depend upon the type of connection between the flexible member 22 and the first end closure 20.

The air spring 10 further includes a first mounting member or stud 36 projecting from the first end closure 20 in a first direction. The first mounting member 36 may be a separate component secured to the first end closure 20 or a component integrally formed with the first end closure 20. Indeed, as will be described in greater detail below, the first end closure 20 and first mounting member 36 may be integrally formed together as a unitary structure.

Barbs 40 are provided on an outer surface 42 of the first mounting member 36. The barbs 40 project radially outward from the outer surface 42 and have a spaced arrangement along the first direction. Each barb 40 may extend completely or partially around the outer surface 42. In the embodiment shown, a first set 46 of barbs 40 and a second set 48 of barbs 40 are provided on diametrically opposite sides of the first mounting member 36. The first mounting member 36 may be substantially cylindrical with the barbs 40 projecting radially outward across arcuate sections (not shown) of the outer surface 42. Alternatively, as shown, the first mounting member 36 may include a first flat portion 50 and a second flat portion 52 on diametrically opposite sides of the outer surface 42 so as to define a truncated cylinder. The first set 46 of barbs 40 is provided on the first flat portion 50, and the second set 48 of barbs 40 is provided on the second flat portion 52.

FIG. 3A illustrates the first set 46 of barbs 40 in further detail. Each barb 40 includes a substantially triangular cross section defined by the outer surface 42, a leading surface 60 extending outwardly from the outer surface 42 and toward the first end closure 20 at a first angle 62, and a trailing surface 64 extending outwardly from the outer surface 42 at a second angle 66. The leading surface 60 and trailing surface 64 converge at a corner having a peripheral edge 68. Advantageously, the slope of the leading surface 60 toward the peripheral edge 68 is steeper than that of trailing edge. To this end, the first angle 62 may be less than the second angle 66.

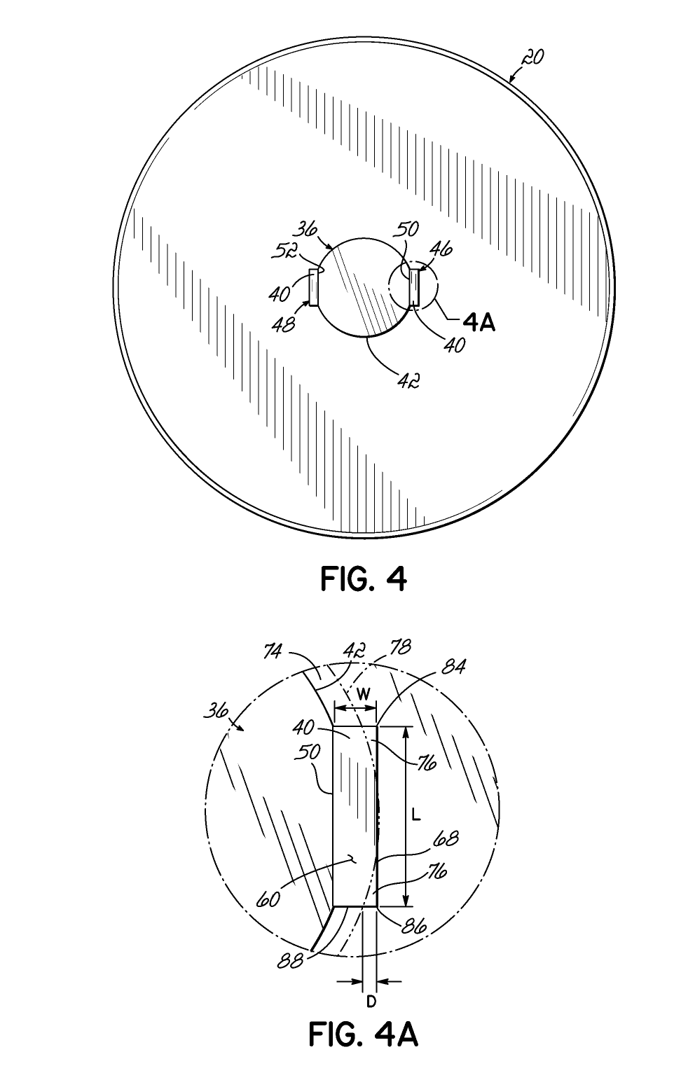

The first angle 62 and second angle 66 are selected so that the first mounting member 36 is easy to install in a hole 74 (FIG. 4A) in the first component 12 (FIG. 1). For example, as shown FIGS. 4 and 4A, the first mounting member 36 and barbs 40 are sized so that an area of interference 76 is created between the barbs 40 and an inside surface 78 of the hole 74. The leading surface 60 serves as a ramp so that the area of interference 76 is gradually deformed as the first mounting member 36 is inserted into the hole 74. If the first angle 62 is relatively large so that the leading surface 60 abruptly protrudes from the outer surface 42, this deformation may not occur as readily. One example of a suitable slope for the leading surface 60 is when the first angle 62 is approximately 30 degrees (i.e., the leading surface 60 has a slope of approximately −60 degrees relative to a horizontal plane).

The trailing surface 64 serves to retain the first mounting member 36 against a surface 80 (FIG. 1) of the first component 12, as will be described in greater detail below. This purpose is best served when the trailing surface 64 is substantially perpendicular to the outer surface 42 (so as to have no slope relative to a horizontal plane) or angled slightly toward the first end closure 20 (so as to have a slightly negative slope relative to a horizontal plane). Thus, one example of orientation for the trailing surface 64 is when the second angle 66 is approximately 90 degrees. Although the trailing surface 64 may alternatively be angled away from the first end closure 20 so as to have a positive slope, the slope should be kept small enough to prevent significant increases in the stiffness of the barb 40. The slope should also be kept small enough to enable the trailing surface 64 to effectively retain the first mounting member 36 against the first component 1 2.

Still referring to FIGS. 4 and 4A, the area of interference 76 is located around opposed corners 84, 86 of each barb 40. The area of interference 76 is substantially wedge-shaped because the peripheral edge 68 does not have an arcuate profile similar to that of the hole 74. This is because the barbs 40 extend outward from the first flat portion 50 or second flat portion 52 of the outer surface 42. Applicants have found that designing the barbs 40 to have the area of interference 76 at the corners strikes a balance between: 1) providing enough interference so that the trailing surface 64 can effectively retain the first mounting member 36 against the surface 80 after extending through the hole 74, and 2) preventing the interference from making it too difficult to initially insert the first mounting member 36 into the hole 74. Such an arrangement also increases the lateral restraint on the first mounting member 36 in the hole 74.

The barb 40 shown in FIG. 4A has a width W, a length L, and an overlap distance D measured between the peripheral edge 68 and an inside surface 78 of the hole 74 (where the inside surface 78 intersects a side edge 88 of the barb 40) when the first mounting member 36 is within the hole 74. The first mounting member 36 and barbs 40 may be sized so that the center of the peripheral edge 68 is substantially tangent to the inside surface 78. The length L of the barb 40 may be about 5 times the width W of the barb 40, and the overlap distance may be about one-third of the width W. For example, in one representative embodiment where the hole 74 has a diameter of about 0.69 inches, the width W of the barb 40 is about 0.03 inches, the length L is about 0.15 inches, and the overlap distance D is about 0.01 inches. These dimensions and their relationships may vary depending on the size of the hole 74 and other design considerations.

Indeed, it will be appreciated that the barbs 40 may be designed to have a larger or smaller area of interference 76 based on material properties. If a relatively soft material is used to form the barbs 40, the barbs 40 can be designed to provide a greater amount of interference without compromising the ease of installation of the first mounting member 36. Conversely, if a relatively stiff or rigid material is used to form the barbs 40, the barbs 40 may be designed to provide less interference with the hole 74.

The barbs 40 and first mounting member 36 may be integrally formed together. For example, the barbs 40 and the first mounting member 36 may be constructed from the same material during a single molding operation to form a unitary structure. Alternatively, the first mounting member 36 may be molded or otherwise constructed from a first material and then over-molded with a second material to form the barbs 40. The barbs 40 may be formed from any type of thermoplastic or other material having sufficient elastic deformation properties. One such material is Zytel® nylon, available from DuPont.

The first mounting member 36 may be secured to the first end closure 20 using conventional fastening techniques. In one embodiment, the first mounting member 36 is constructed with a threaded portion (not shown) configured to engage a tapped hole (not shown) formed in the first end closure 20. Alternatively, the first mounting member 36 and first end closure 20 may be integrally formed together. This may be achieved by molding the first mounting member 36 and first end closure 20 from the same material to form a unitary structure. In some embodiments, it may be desirable for the first mounting member 36—particularly the barbs 40 thereof—to be constructed from a softer material than the first end closure 20. The components may be integrally molded together in such embodiments by molding the first end closure 20 from a first material and then molding the first mounting member 36 and barbs 40 from a second material having a stiffness less than the first material. One example of a suitable first material is Hytrel® (available from DuPont), and one example of a suitable second material is Zytel®.

To install the air spring 10, the first mounting member 36 is inserted into the hole 74 provided in the first component 12. As the first mounting member 36 is pressed into the hole 74, the leading surface 60 of the barbs 40 acts as a ramp until the area of interference 76 contacts the inside surface 78. The area of interference 76 is deformed until the barb 40 is pushed through the hole 74, at which point the area of interference 76 springs back toward its normal shape. The trailing surface 64 at the area of interference 76 then confronts the surface 80 on the first component 12 surrounding the hole 74. This overlap helps prevent the first mounting member 36 from being pulled back through the hole 74 during operation of the vehicle 18.

By providing a plurality of barbs 40, a ratcheting-like effect is created as the first mounting member 36 is pushed into the hole 74. Thus, although the first barb 40 to exit the hole 74 may help retain the first mounting member 36 in the manner described above, the first end closure 20 may still be spaced from the first component 12. An individual may continue to push the first mounting member 36 into the hole 74 to move the first end closure 20 closer toward the first component 12. This results in successive barbs 40 exiting the hole 74, with each barb 40 serving to retain the first mounting member 36 until the next barb 40 exits the hole 74. Accordingly, when the first end closure 20 contacts the first component 12, the last barb 40 to exit the hole 74 helps maintain this contact.

Although only the first mounting member 36 and first end closure 20 are described above, those skilled in the art will appreciate that description may equally apply to the second end closure 24 (FIG. 1) and a second mounting member 92 projecting in a second direction from the second end closure 24. The second mounting member 92 and second end closure 24 may have substantially the same construction as the first mounting member 36 and first end closure 20. Alternatively, the second mounting member 92 and second end closure 24 may have a different construction. For example, the second end closure 24 and second mounting member 92 may be a single component in the form of a piston (not shown). The barbs 40 in such an embodiment may be provided on the portion of the piston that mounts to the second component 14.

Regardless of their construction, the first mounting member 36 and second mounting member 92 may be used to install the air spring 10 to holes of different thicknesses due to the ratcheting-like effect described above. An individual need not worry about whether the thickness of the component to which the air spring 10 is mounted corresponds to the length of the first mounting member 36 or second mounting member 92. The plurality of barbs 40 helps ensure that the first end closure 20 and second end closure 24 can be retained against the first component 12 and second component 14, respectively, regardless of the thickness of the first component 12 and second component 14. This represents an advantage over other air springs that are snap-mounted.

Furthermore, unlike conventional air springs installed using nuts and bolts, the air spring 10 does not require additional tools (e.g., wrenches) for installation. This reduces the amount of time and effort to install the air springs. The barbs 40 also eliminate the need for additional fasteners, although such fasteners may still be used if desired. The savings in installation time and elimination of additional tools and/or parts reduces the overall cost associated with the use of the air spring 10.

To remove the air spring 10 from the vehicle 18, an individual pulls the first end closure 20 away from the first component 12. The force applied must be sufficient to overcome the resistance created by contact between the trailing surface 64 of the barb 40 and the surface 80. To this end, the barbs 40 may be designed to retain the first mounting member 36 within the hole 74 under the loads experienced during operation of the vehicle 18, but not under the forces applied by an individual. The second end closure 24 may be pulled in a similar manner to complete the removal process. Thus, as with its installation, the removal of the air spring 10 may not require additional tools and can be completed in a time-efficient manner.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. For example, those skilled in the art will appreciate that although the first component 12 and second component 14 are shown as being located in the suspension system 16 of a vehicle 18, the air spring 10 may be installed elsewhere on the vehicle 18 or in a different article of manufacture (e.g., a machine). The invention in its broader aspects is therefore not limited to the specific details, representative apparatus and methods and illustrative examples shown and described. Accordingly, departures may be made from such details without departing from the scope or spirit of the general inventive concept.

What is claimed is:

1. An air spring, comprising:
a first end closure;
a flexible member coupled to the first end closure and defining a pressurizable chamber; and
a first mounting member projecting from the first end closure in a first direction, the first mounting member having an outer surface and a plurality of barbs projecting outward from the outer surface, the plurality of barbs having a spaced arrangement along the first direction.

2. The air spring of claim 1, further comprising:
a second end closure coupled to the flexible member opposite the first end closure; and
a second mounting member projecting from the second end closure in a second direction, the second mounting member having an outer surface and a plurality of barbs projecting outward from the outer surface, the plurality of barbs on the second mounting member having a spaced arrangement along the second direction.

3. The air spring of claim 1, wherein the plurality of barbs comprises:
first and second sets of barbs located on diametrically opposite sides of the outer surface.

4. The air spring of claim 3, wherein the first mounting member is substantially cylindrical with first and second flat portions on diametrically opposite sides of the outer surface, the first set of barbs being provided on the first flat portion, and the second set of barbs being provided on the second flat portion.

5. The air spring of claim 1, wherein the first mounting member is integrally formed with the first end closure.

6. The air spring of claim 5, wherein the first mounting member and first end closure are unitary.

7. The air spring of claim 5, wherein the first end closure is molded from a first material and the first mounting member is molded from a second material having a lower stiffness than the first material.

8. An air spring, comprising:
a first end closure;
a flexible member coupled to the first end closure and defining a pressurizable chamber; and
a first mounting member projecting from the first end closure in a first direction, the first mounting member having and outer surface and a plurality of barbs projecting outward from the outer surface, the plurality of barbs having a spaced arrangement along the first direction;
wherein each barb has a triangular cross-section defined by the outer surface of the first mounting member, a leading surface extending outwardly from the outer surface and toward the first end closure at a first angle, and a trailing surface extending outwardly from the outer surface at a second angle, the leading and trailing surfaces converging at a peripheral edge of the barb, and the first angle is less than the second angle.

9. The air spring of claim 8, wherein the second angle is approximately 90 degrees.

10. The air spring of claim 9, wherein the first angle is approximately 30 degrees.

11. The air spring of claim 8, further comprising:
a second end closure coupled to the flexible member opposite the first end closure; and
a second mounting member projecting from the second end closure in a second direction, the second mounting member having an outer surface and a plurality of barbs projecting outward from the outer surface, the plurality of barbs on the second mounting member having a spaced arrangement along the second direction.

12. The air spring of claim 8, wherein the plurality of barbs comprises:
first and second sets of barbs located on diametrically opposite sides of the outer surface.

13. The air spring of claim 12, wherein the first mounting member is substantially cylindrical with first and second flat portions on opposite sides of the outer surface, the first set of barbs being provided on the first flat portion, the second set of barbs being provided on the second flat portion, and the peripheral edge of each barb being substantially parallel to the first and second flat portions.

14. The air spring of claim 8, wherein the first mounting member is integrally formed with the first end closure.

15. The air spring of claim 14, wherein the first mounting member and first end closure are unitary.

16. The air spring of claim 14, wherein the first end closure is molded from a first material and the first mounting member is molded from a second material having a stiffness lower than the first material.

17. A method of forming an air spring, comprising:
constructing an end closure;
constructing a mounting member having an outer surface with a plurality of barbs projecting radially outward;
coupling the mounting member to the end closure so that the mounting member projects from the end closure in a first direction, the plurality of barbs being arranged along the first direction; and
coupling the end closure to a flexible member, the flexible member defining a pressurizable chamber.

18. The method of claim 17, wherein the mounting member is integrally formed with the end closure.

19. The method of claim 18, wherein the mounting member and end closure are unitary.

20. The method of claim 18, wherein constructing the end closure comprises:
molding the end closure from a first material, wherein constructing the mounting member comprises molding the mounting member from a second material having a stiffness less than the first material, and wherein coupling the mounting member to the end closure comprises integrally molding the mounting member with the end closure.
